(19) United States
(12) Patent Application Publication
(10) Pub. No.: US 2018/0330581 A1
(43) Pub. Date: Nov. 15, 2018

(54) MOBILE COMMUNICATION DEVICE FOR DEACTIVATING A ZIPPER ALARM

(71) Applicants: Joelene Latief, (US); Emily Hom, (US)

(72) Inventors: Joelene Latief, Daly City, CA (US); Emily Hom, San Mateo, CA (US); Leon Young, El Cerrito, CA (US)

(73) Assignees: Joelene Latief, Dale City, CA (US); Emily Hom, San Mateo, CA (US)

(21) Appl. No.: 15/975,081

(22) Filed: May 9, 2018

Related U.S. Application Data
(60) Provisional application No. 62/504,281, filed on May 10, 2017.

(51) Int. Cl. G08B 3/10; G08B 6/00; G07C 9/00; G06K 19/07

(52) U.S. Cl. CPC G08B 3/1025; G08B 6/00; G07C 9/00182; G07C 2009/00777; G07C 2009/0019; G07C 2009/00293; G06K 19/0723

(57) ABSTRACT

Embodiments relate to a security system for securing items within any cavity, of any object, which may be opened or closed with a zipper. The security system includes functionality to detect the opening and/or detect the closing of a zipper. The security system may be configured to trigger an alarm if the zipper is opened while the security system is in an “armed” state. The security system may be configured to not trigger the alarm if the zipper is opened while the security system is in a disarmed state. The security system may be armed and/or disarmed via a wireless signal.

### BENEFIT CLAIMS; RELATED APPLICATIONS; INCORPORATION BY REFERENCE

This application claims the benefit of U.S. Provisional Patent Application 62/504,281, filed May 10, 2017, which is hereby incorporated by reference.

### TECHNICAL FIELD

The present disclosure relates to securing a cavity of an object. Specifically, the present disclosure relates to activating and de-activating a security system corresponding to a zipper of the cavity of the object using a wireless communication device.

### BACKGROUND

Pickpocketing is the act of stealing items from people's pockets or bags (e.g., purses, handbags, or backpacks). Pickpocketing is a common problem for people in towns and cities throughout the world. To help avoid, pickpocketing, people carry bags that are zipped closed. However, pick-pocketers are skilled at discretely unzipping bags. Once unzipped, pick-pocketers quickly steal items by reaching in the bag, often without the bag owner even realizing that the bag has been unzipped.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrates one or more components of a security system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. Security System Features
2. Example Set of Security System Components
3. Computer Networks and Cloud Networks
4. Microservice Applications
5. Miscellaneous; Extensions
6. Hardware Overview

### 1. Security System Features

Embodiments relate to a security system for securing items within any cavity, of any object, which may be opened or closed with a zipper. A cavity or compartment that may be opened or closed with a zipper may be referred to herein as a “zippered compartment.” The security system may be used for securing items, for example, within zippered compartments of a purse, a handbag, or a backpack. The security system may also be used for securing larger object cavities such as zippered compartments within a luggage bag.

In an embodiment, the security system includes functionality to detect the opening and/or detect the closing of a zipper. The security system may execute actions in response to the detection operations, based on a current state of the security system. As an example, the security system may be configured to trigger an alarm if the zipper is opened while the security system is in an “armed” state. The security system may be configured to not trigger the alarm if the zipper is opened while the security system is in a disarmed state. The alarm may be a combination of audible elements (e.g., alarm sound), visual elements (e.g., lights), and tactile elements (e.g., vibration) implemented on a single or multiple devices. The alarm may further include transmissions of notifications (e.g., text messages, emails, pop-ups, and application messages).

In an embodiment, the security system may be armed and/or disarmed via a wireless signal. As an example, the security system for a purse may be armed or disarmed using a ring which emits a signal recognized by a signal reader within the purse. A device (e.g., a ring) which is used to arm or disarm the security system may also implement an alarm (e.g., a vibration) triggered by the security system.

### 2. Example Set of Security System Components

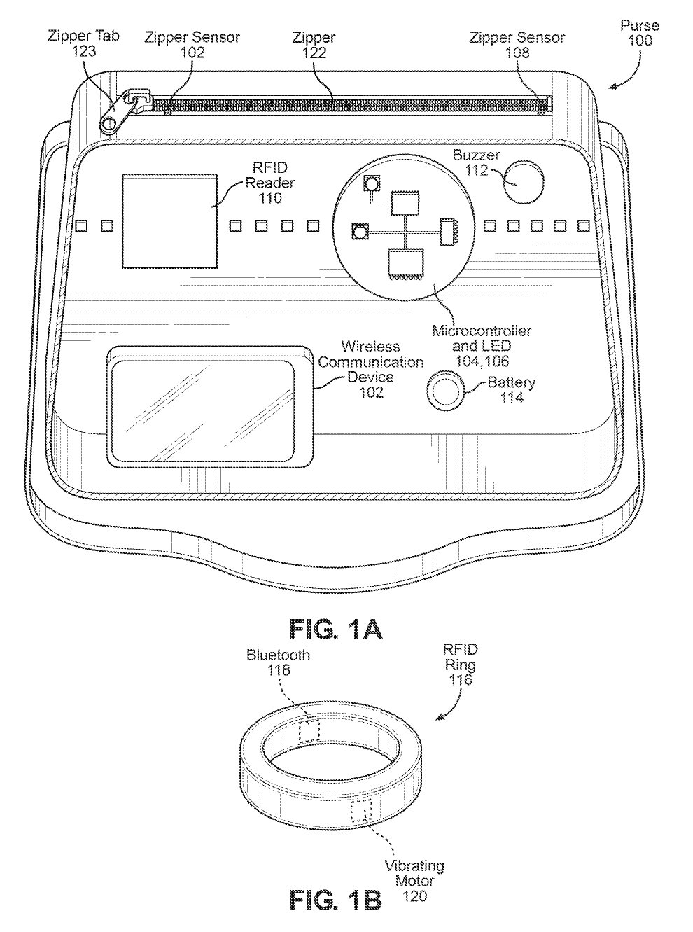

As described above, embodiments described herein may be applicable for securing any zippered cavity (also referred to herein as “zippered compartment”) of any object. FIGS. 1A and 1B illustrate an example set of components of a security system in accordance with one or more embodiments. Software and/or hardware components described with relation to FIGS. 1A and 1B may be omitted or associated with a different set of functionalities than described herein. Software and/or hardware components, not described herein, may be used within an environment in accordance with one or more embodiments. Accordingly, the example set of components described in relation to FIGS. 1A and 1B should not be constructed as limiting the scope of any of the claims.

FIG. 1A illustrates components of a security system implemented for a purse (100). As described above, embodiments are applicable to any object with a zippered compartment. The example specifically references a purse (100) for purposes of clarity and should not be construed as limiting the scope of any of the claims.

The purse (100), as illustrated in FIG. 1A, includes a zipper (122), zipper sensors (102, 108), a microcontroller (104), an LED (106), an RFID reader (110), a buzzer (112), a wireless communication device (102), and a battery (114). The battery (114) may be used to power one or more components of the purse (100) described below.

In an embodiment a zipper (122) includes two flexible current conducting strips of material with interlocking projections along the length of the of the zipper. The projections may be closed or opened by pulling a zipper tab (123) along the projections. When the zipper is opened, the interior compartment of the purse (100) may be accessed (e.g., by a user reaching his hand into the purse through the zipper opening. When the zipper is closed, the interior compartment of the purse (100) may not be accessed.

In an embodiment, a zipper sensor (e.g., zipper sensors 102 and 108) is an electro-magnetic sensor used to detect when the zipper tab (123) has been pulled along the projections of the zipper from one side of the zipper sensor to another size of the zipper sensor. A zipper sensor may include conductive material. A zipper sensor may be configured such that the zipper sensor completes an electric circuit when the zipper tab (123) is placed above the zipper sensor. The zipper sensor does not complete the circuit when the zipper tab (123) is not placed above the zipper sensor. Each zipper sensor may include sets of conductive thread that are close together and that can complete a circuit with the zipper tab (123). When the zipper tab (123) is pulled across the zipper sensor (102), a circuit is completed for a brief period of time when the zipper tab (123) is in contact with elements of the zipper sensor (102). Alternatively, or in addition, a zipper sensor may include two elements of conductive materials on opposite sides of a zipper. The two elements complete a circuit when the zipper is in a closed state, and do not complete the circuit when the zipper is open state. When the zipper state is modified from a closed state to an open state, the circuit breaks. Detection of the circuit breaking is used determine that the zipper has been opened.

Any number of zipper sensors (e.g., one or more) may be used in accordance with one or more embodiments. Multiple zipper sensors may be used to determine a direction in which the zipper tab is pulled. As a zipper tab (123) is pulled across the zipper (122), each of zipper sensors may complete a circuit at different corresponding periods of time. If zipper sensor 102 completes a circuit before zipper sensor 108, then the security system determines that the zipper tab (123) is being pulled from left to right (in the illustrated purse 100). Pulling the zipper tab (123) from left to right may be identified as opening of the zipper (122) based on stored metadata associating the left-to-right direction with the opening of the purse (100). Conversely, pulling the zipper tab (123) from right to left may be identified as closing of the zipper (122) based on stored metadata associating the right-to-left direction with the closing of the purse (100). In an embodiment, stitching connected to the zipper (122) may be required to complete a circuit with the zipper sensors and the zipper (122).

In an embodiment, a microcontroller (104) corresponds to a computer on a small integrated circuit. The microcontroller (104) may include one or more CPUs (processor cores), memory, and programmable input/output peripherals. The microcontroller (104) may process signals to determine whether a circuit corresponding to the zipper sensors has been completed. The microcontroller (104) may further be configured to determine an armed or disarmed state of the security system. The microcontroller (104) may further be configured to determine whether to trigger an alarm in response to detecting the opening of the zipper (122).

In an embodiment, the purse (100) includes a Radio Frequency Identification (RFID) reader (110). An RFID reader (110) is a component that is used to gather signals wirelessly transmitted by an RFID tag. The RFID reader (110) may be configured for receiving signals from active battery-powered RFID tags or passive RFID tags which collect energy from RFID readers. Signals received by the RFID reader (110) from particular RFID tags (e.g., an owner's RFID tag, an owner's relative's RFID tag, an authorized user's RFID tag) may be used to activate and/or deactivate the security system.

In an embodiment, any wireless communication device (102) may be used in addition to or instead of the RFID reader 110. While RFID readers and RFID tags are described in detail above, embodiments are applicable to any wireless communication system which is suitable for arming or disarming the security system wirelessly. The wireless communication device (102) may be configured for detecting signals for arming or disarming the security system. The wireless communication device (102) may be configured for authenticating requests for disarming or arming the security system. In an example, the wireless communication device (102) is configured to transmit any security system deactivation signal to a secondary verification system. The wireless communication device (102) confirms the validity of the security system deactivation signal based on the response from the secondary verification system.

In an embodiment, any type or number of alarms may be triggered when the zipper is opened while the security system is armed. The alarm types include audible (e.g., sound alarms), visible (e.g., light alarms), and tactile (e.g., vibration alarms). Alarms may be implemented on the object being secured, and/or on other objects (e.g., the deactivation device). The buzzer (112) is an example of an audible alarm that may be triggered by the security system. The buzzer (112) may beep, buzz, vibrate, etc. when the zipper (122) is opened while the security system is armed. In an embodiment, an LED (106) may be used to indicate a visible alarm that may be triggered by the security system. The LED (106) may flash light and/or illuminate a particular color (e.g., red) to indicate that the alarm has been triggered. The LED (106) may also serve as an alarm state display. For example, the LED (106) may display a green light when the security system is not armed and display a blue light when the security system is armed.

In an embodiment, any deactivation device may be configured for disarming the security system. Examples of deactivation devices may include, but are not limited to, wearables of any type, rings, bracelets, watches, keychains, and cell phones. The deactivation device may include components for wirelessly transmitting a deactivation signal for disarming the security system. The security system may be configured to require the deactivation device to be within a close range (e.g., 1-2 inches) of the wireless communication device (102) of the purse (100) in order to deactivate the security system. Deactivation devices may communicate with a reader of the purse (100) using any communication protocol. Examples of communication protocols include, but are not limited to, RFID, NFC, Bluetooth, Z-wave, and ZigBee. Deactivation signals may further require that the deactivation device is located within a certain threshold distance (e.g., 2 inches) from the signal reader of the purse (100).

In one example, the deactivation device is implemented as an RFID ring (116), as illustrated in FIG. 1B. The RFID ring (116) is a ring with an RFID tag which emits a deactivation signal recognized by the RFID reader (110). The security system may be deactivated when the RFID ring (116) is placed in close proximity to the RFID reader (110) of the purse.

The RFID ring (116) may also include a Bluetooth signal transceiver (118) to communicate with the wireless communication device (102) of the purse. The Bluetooth signal transceiver (118) may be used to detect when the purse (100) is more than a threshold distance away from the RFID ring (116). If the Bluetooth signal transceiver (118) is more than the threshold distance away from the RFID ring (116), then an alarm may be triggered. For example, the vibrating motor (120) of the RFID ring (116) may be configured to vibrate any time the purse (100) is more than the threshold distance away from the RFID ring (116).

In an embodiment, a deactivation device may be used to deactivate multiple different security systems corresponding to different cavities of the same object, and/or different cavities of different objects. As an example, a user's ring may be configured for deactivating the user's purse and the user's mother's purse. In an embodiment, an application (e.g., a mobile application) may be used to configure the ring. The owner of a ring may authenticate the ring to the application, for example, using a ring ID wirelessly obtained by a phone from the ring using Near Field Communication (NFC) or Bluetooth Low Energy (BLE) devices. The application may further require a password for setting up configuration for the ring. The application may be used to select preferences (e.g., when to sound an alarm, what type of alarm to sound, which purses to associate with the ring, what levels of permissions to provide to different users, etc.). The application may store purse-specific preferences in addition to ring-specific preferences. To change the preference of an object, the user needs to authenticate to the application information that proves the user owns the object. The application then communicates the preferences to the object such that the object changes future behavior without being required to reconnect to the application.

As an example, once a purse and a wearable deactivation device have both been separately authenticated in the application, and also linked together, information about the wearable deactivation device (such as a ring ID) is sent to the purse. The purse records which wearable deactivation devices can disarm the security system of the purse. The information about the purse is optionally sent to the wearable deactivation device. The wearable deactivation device records which purses can be opened by the wearable deactivation device. In one embodiment, the purse trusts any wearable deactivation device that communicates, to the purse, a key specific to the purse, without regard to the identity of the wearable deactivation device. The application or the wearable deactivation device can generate the key when the purse is unlocked or otherwise be authenticated to establish ownership. In another embodiment, the purse trusts only the rings that are identified in a purse storage system, as being authorized to disarm the purse security system.

A security system for the cavity of the purse (or any other object) may be deactivated based on location. As an example, the security system for a GPS-enabled object may be deactivated any time the object is detected within the owner's home. The security system may be deactivated any time the owner's home door is unlocked. The unlocking of the home door of a user that lives alone indicates that the user is home. Conversely, detecting that a user has left the home (e.g., based on GPS-determined location of purpose or locking of home door) may be used as a signal to arm the purse (100).

In an embodiment, the security system may be activated a certain amount of time (e.g., 30 seconds) after the security system has been deactivated. In another embodiment, the security system may be activated each time the closing of a zipper is detected. The security system may be activated by a wireless device and/or with a mobile application.

In an embodiment, the security system may be activated or deactivated by buttons on or in the purse. The security system may be activated or deactivated using mobile applications.

### 3. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 4. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally, or alternatively, the target microservice may be connected to one or more other microservices such that an alert is input to the other micro services. Other microservices may perform responsive actions based on the above techniques, including, but not limited to, deploying additional resources, adjusting system configurations, and/or generating GUIs.

Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the micro services manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
a zipper enclosing a cavity of an object, wherein the object comprises:
a zipper sensor operatively coupled to the zipper;
one or more wireless communication devices;
one or more processors operatively coupled to the zipper sensor and the one or more wireless communication devices; and
one or more non-transitory computer readable media storing:
first authentication information for authenticating a portable device, separate from the object, to the object;
instructions which, when executed by the one or more processors, cause performance of operations comprising:
detecting that a deactivation signal has been received, via at least one of the one or more wireless devices, from a portable device that is separate from the object, wherein the deactivation signal comprises second authentication information;
based at least in part on determining that the second authentication information satisfies the first authentication information, at least temporarily deactivating a security mode for the zipper;
detecting that the zipper is open, and, in response, if the security mode for the zipper is active, transmitting a zipper open signal via at least one of the one or more wireless devices to the portable device;
wherein the zipper open signal is configured to, when received, trigger at least one localized notification on the portable device.

2. The system of claim 1, wherein the operations further comprise:
prior to detecting the first opening of the zipper:
updating the zipper alarm to an active state in response to receiving, via the zipper alarm
control sensor, an alarm activation signal corresponding to the zipper alarm.

3. The system of claim 1, wherein the zipper sensor senses the opening of the zipper in response to the completion of a circuit, wherein the circuit is completed when a pull tab of the zipper connects a first end of a thread stitching to a second of the thread stitching.

4. The system of claim 1, wherein the object comprises a zipper security device configured, while the security mode for the zipper is active, to prevent the opening of the zipper or provide a localized notification on the object in response to detecting the zipper is open.

5. The system of claim 1, further comprising reactivating the security mode for the zipper after a threshold amount of time has passed since the security mode was deactivated.
